(19) United States
(12) Patent Application Publication
(10) Pub. No.: US 2016/0305281 A1
(43) Pub. Date: Oct. 20, 2016

(54) GAS TURBOMACHINE INCLUDING A COUNTER-FLOW COOLING SYSTEM AND METHOD

(71) Applicant: General Electric Company, Schenectady, NY (US)

(72) Inventors: Henry Grady Ballard, JR., Easley, SC (US); Kenneth Damon Black, Travelers Rest, SC (US); John David Memmer, Simpsonville, SC (US)

(21) Appl. No.: 15/175,576

(22) Filed: Jun. 7, 2016

Related U.S. Application Data
(63) Continuation-in-part of application No. 13/461,035, filed on May 1, 2012.

(51) Int. Cl. F01D 25/14; F01D 25/12; F01D 9/02; F04D 29/58; F04D 29/52; F02C 3/04; F01D 25/24

(52) U.S. Cl. CPC F01D 25/14; F02C 3/04; F01D 25/12; F01D 25/24; F04D 29/5826; F04D 29/522; F01D 9/02; F05D 2220/32; F05D 2240/35; F05D 2260/213

(57) ABSTRACT

A gas turbomachine includes a casing assembly surrounding a portion of the gas turbomachine. The casing assembly includes an inner casing portion defining a casing volume V_{C} and a counter-flow cooling system arranged within the inner casing portion. The counter-flow cooling system includes a plurality of ducts that collectively define a channel volume V_{ch}. The plurality of ducts is configured and disposed to guide cooling fluid through the casing assembly in a first axial direction and return cooling fluid through the casing assembly in a second axial direction that is opposite the first axial direction. The casing volume and the channel volume define a volume ratio of about 0.0002<V_{Ch}/V_{C}<0.9.

### CROSS-REFERENCE TO RELATED APPLICATION

This application is a Continuation-In-Part of U.S. application Ser. No. 13/461,035 filed May 1, 2012, the disclosure of which is incorporated herein by reference in its entirety.

### BACKGROUND OF THE DISCLOSURE

The subject matter disclosed herein relates to the art of turbomachines and, more particularly, to a gas turbomachine including a counter-flow cooling system.

Many turbomachines include a compressor portion linked to a turbine portion through a common compressor/turbine shaft or rotor and a combustor assembly. The compressor portion guides a compressed airflow through a number of sequential stages toward the combustor assembly. In the combustor assembly, the compressed airflow mixes with a fuel to form a combustible mixture. The combustible mixture is combusted in the combustor assembly to form hot gases. The hot gases are guided to the turbine portion through a transition piece. The hot gases expand through the turbine portion rotating turbine blades to create work that is output, for example, to power a generator, a pump, or to provide power to a vehicle. In addition to providing compressed air for combustion, a portion of the compressed airflow is passed through the turbine portion for cooling purposes.

### BRIEF DESCRIPTION OF THE DISCLOSURE

According to one aspect of the exemplary embodiment, a gas turbomachine includes a casing assembly surrounding a portion of the gas turbomachine. The casing assembly includes an inner casing portion defining a casing volume V_{c} and a counter-flow cooling system. The counter-flow cooling system includes a plurality of ducts that collectively define a channel volume V_{Ch}. The plurality of ducts is configured and disposed to guide cooling fluid through the casing assembly in a first axial direction and return cooling fluid through the casing assembly in a second axial direction that is opposite the first axial direction. The casing volume and the channel volume define a volume ratio of about 0.0002<V_{Ch}/V_{C}<0.9.

According to another aspect of the exemplary embodiment, a method of delivering cooling fluid through a gas turbomachine includes guiding a cooling fluid into a casing assembly of the turbine portion of the gas turbomachine. The casing assembly includes an inner casing portion defining a casing volume V_{C}. The method also includes passing the cooling fluid into a first duct member extending axially through the casing assembly in a first direction, guiding the cooling fluid through a cross-flow duct fluidly coupled to the first duct member in a second direction, delivering the cooling fluid from the cross-flow duct into a second duct member that extends substantially parallel to the first duct member. The first duct member, cross-flow duct, and second duct member define a channel volume V_{Ch}. The cooling fluid is passed through the second duct member in a third direction that is substantially opposite to the first direction. The casing volume and the channel volume define a volume ratio of about 0.0002<V_{Ch}/V_{C}<0.9.

In accordance with yet another aspect of the exemplary embodiment, a gas turbomachine includes a compressor portion, a combustor assembly fluidly connected to the compressor portion, and a turbine portion fluidly connected to the combustor assembly and mechanically linked to the compressor portion. One of the compressor portion and the turbine portion includes a casing assembly having an inner casing portion defining a casing volume V_{C}. A counter-flow cooling system is arranged in one of the compressor portion and the turbine portion. The counter-flow cooling system includes a plurality of ducts collectively defining a channel volume V_{ch}. The plurality of ducts is configured and disposed to guide cooling fluid through the casing assembly in a first axial direction and return cooling fluid through the casing assembly in a second axial direction that is opposite the first axial direction. The casing volume and the channel volume define a volume ratio of about 0.0002<V_{Ch}/V_{C}<0.9.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a gas turbomachine including a turbine portion having a counter-flow cooling system, in accordance with an exemplary embodiment;

FIG. 2 is a partial cross-sectional view of the turbine portion of the gas turbomachine of FIG. 1;

FIG. 3 is a partial perspective view of the counter-flow cooling system, in accordance with an aspect of the exemplary embodiment;

FIG. 4 is a plan view of the counter-flow cooling system of FIG. 3 illustrating a flow redirection member, in accordance with one aspect of the exemplary embodiment;

FIG. 5 is a side view of a cross-flow duct, in accordance with an aspect of the exemplary embodiment;

FIG. 6 is an end view of the cross-flow duct of FIG. 5;

FIG. 7 is a plan view of the counter-flow cooling system of FIG. 3 including a flow redirection member, in accordance with another aspect of the exemplary embodiment; and

FIG. 8 is a plan view of the counter-flow cooling system, in accordance with another aspect of the exemplary embodiment.

The detailed description explains embodiments of the invention, together with advantages and features, by way of example with reference to the drawings.

### DETAILED DESCRIPTION OF THE DISCLOSURE

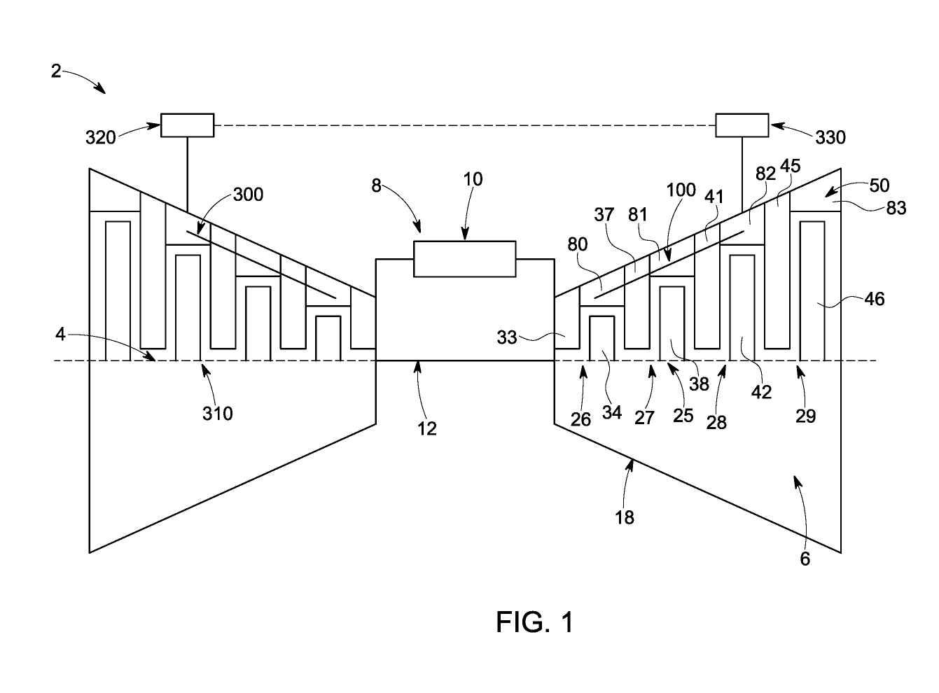

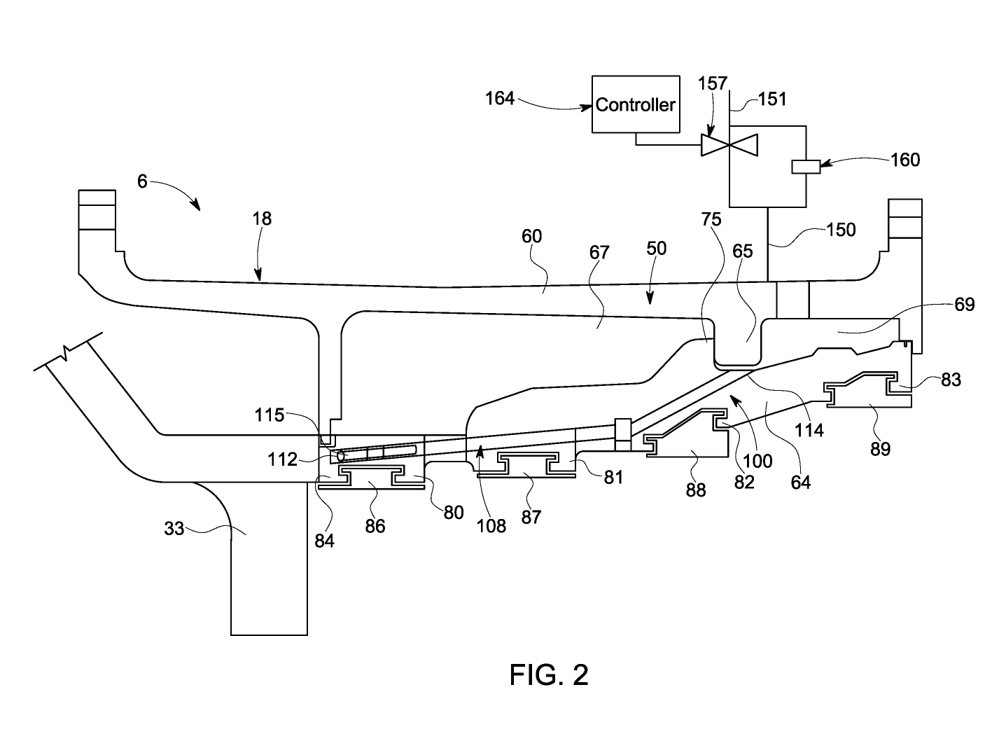

With reference to FIGS. 1 and 2, a gas turbomachine, in accordance with an exemplary embodiment, is indicated generally at 2. Turbomachine 2 includes a compressor portion 4 and a turbine portion 6. Compressor portion 4 is fluidly connected to turbine portion 6 through a combustor assembly 8. Combustor assembly 8 includes a plurality of combustors, one of which is indicated at 10. Combustors 10 may be arranged in a can-annular array about turbomachine 2. Of course it should be understood that other arrangements of combustors 10 may also be employed. Compressor portion 4 is also mechanically linked to turbine portion 6 through a common compressor/turbine shaft 12. There are also extractions taken from various compressor stages that are fluidly connected to turbine components without passing through combustor 10. These extractions are used to cool turbine components such as shrouds and nozzles on the stator, along with buckets, disks, and spacers on the rotor.

Turbine portion 6 includes a housing 18 that encloses a plurality of turbine stages 25. Turbine stages 25 include a first turbine stage 26, a second turbine stage 27, a third turbine stage 28, and a fourth turbine stage 29. First turbine stage 26 includes a first plurality of vanes or nozzles 33 and a first plurality of rotating components in the form of blades or buckets 34. Buckets 34 are mounted to a first rotor member (not shown) that is coupled to shaft 12. Second turbine stage 27 includes a second plurality of vanes or nozzles 37 and a second plurality of blades or buckets 38. Buckets 38 are coupled to a second rotor member (not shown). Third turbine stage 28 includes a third plurality of vanes or nozzles 41 and a second plurality of blades or buckets 42 that are coupled to a third rotor member (not shown). Fourth turbine stage 29 includes a fourth plurality of vanes or nozzles 45 and a fourth plurality of blades or buckets 46 that are coupled to a fourth rotor member (not shown). Of course it should be understood that the number of turbine stages may vary.

Housing 18 includes a casing assembly 50 having an outer casing portion 60 and an inner casing portion 64. A thrust collar 65 extends from outer casing portion 60 towards inner casing portion 64. Thrust collar 65 limits axial movement of inner casing portion 64 during operation of turbomachine 2. A first plenum zone 67 is defined between outer casing portion 60 and inner casing portion 64 upstream of thrust collar 65. A second plenum zone 69 is defined between outer casing portion 60 and inner casing portion 64 downstream of thrust collar 65. First and second plenum zones 67 and 69 are fluidly connected to one or more compressor extractions (not shown). Inner casing portion 64 includes a projection 75 that may engage with thrust collar 65 and a plurality of shroud support elements 80-83. Each shroud support element 80-83 includes a pair of hook elements, such as shown at 84, on shroud support element 80 that support a respective plurality of stationary shroud members 86-89. Shroud members 86-89 provide a desired clearance between inner casing portion 64 and corresponding ones of tip portions (not separately labeled) of buckets 34, 38, 42 and 46. In many cases, shroud members 86-89 include various sealing components that limit working fluid from passing over the tip portions of buckets 34, 38, 42 and 46.

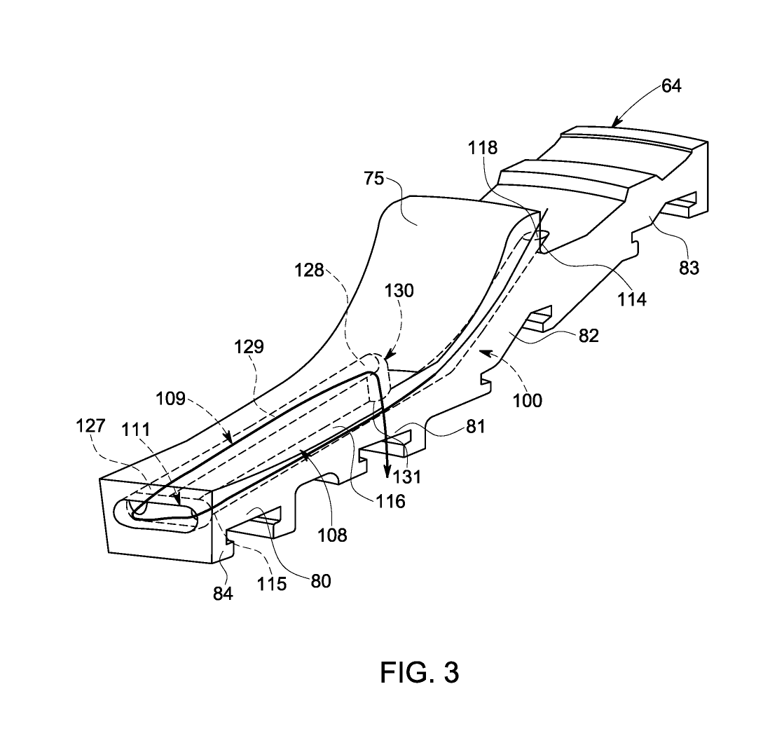

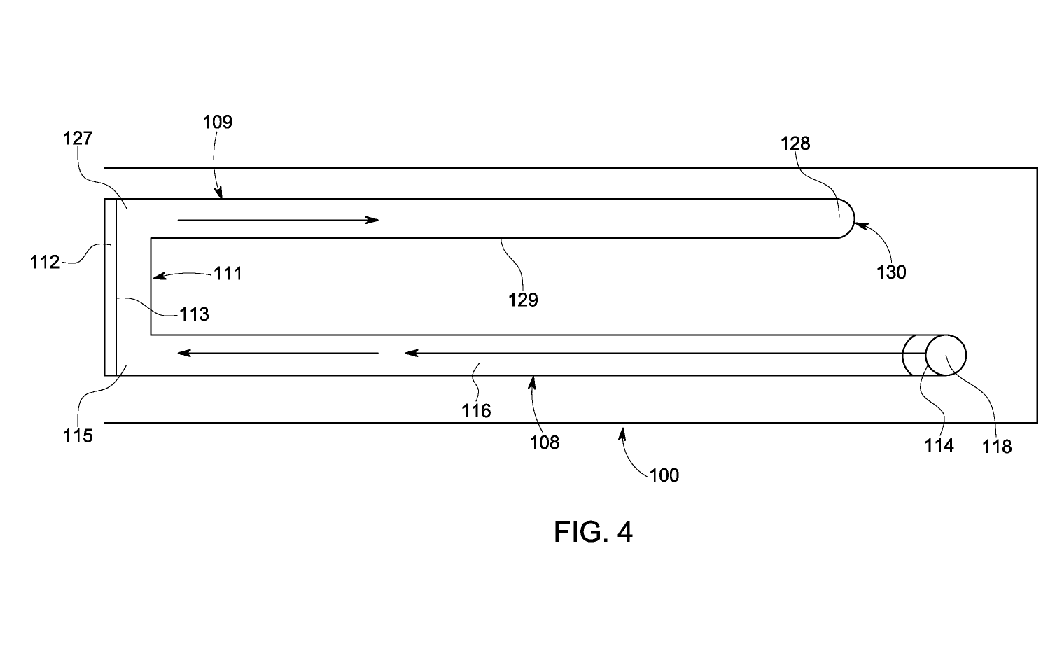

In accordance with an exemplary embodiment, turbomachine 2 includes a counter-flow cooling system 100 provided in inner casing portion 64. As best shown in FIGS. 3 and 4, counter-flow cooling system 100 includes a first duct member 108 fluidly connected to a second duct member 109 by a cross-flow duct 111 having a flow redirection cap or member 112 provided with a generally linear inner surface 113. First and second duct members 108 and 109 extend axially though inner casing portion 64. In addition, first duct member 108 extends substantially parallel to second duct member 109 within inner casing portion 64. Passing cooling flow through duct members 108 and 109 that are arranged in the manner described above reduces circumferential thermal gradients within inner casing portion 64. In addition, a deep convection flow passing within inner casing portion 64 reduces thermal gradients at shroud support elements 80-83. Passing cooling flow through the duct members 108 and 109 in this particular manner reduces bulk temperatures of a plurality the turbine stages 25 to provide a desirable clearance benefit.

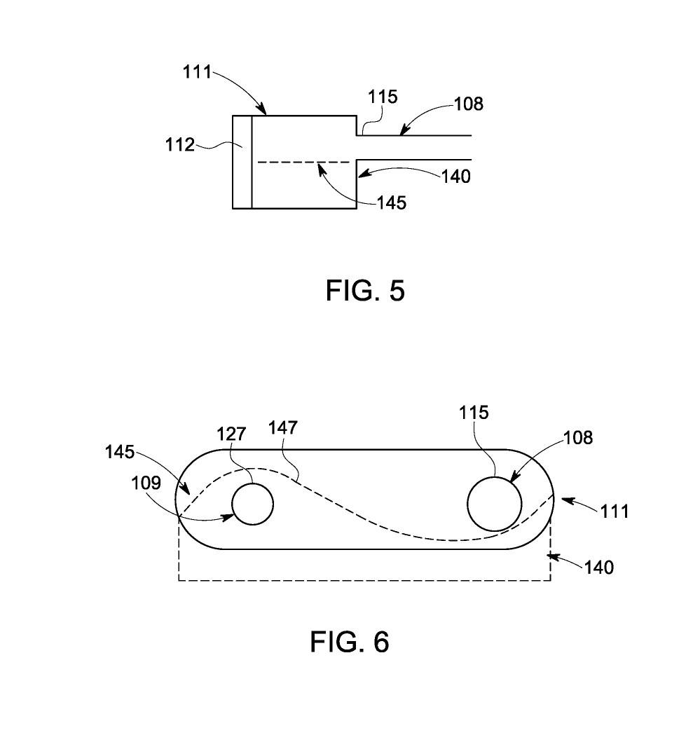

First duct member 108 includes a first end section 114 that extends to a second end section 115 through an intermediate section 116. First end section 114 defines an inlet section 118 that is fluidly connected to second plenum zone 69 while second end section 115 connects with cross-flow duct 111. Second duct member 109 includes a first end portion 127 that extends from cross-flow duct 111 to a second end portion 128 through an intermediate portion 129. Second end portion 128 is coupled to an exit duct portion 130 having an outlet portion 131. Outlet portion 131 leads through inner casing portion 64 and fluidly connects to one or more of vanes 33, 37, 41 and 45. Cooling fluid passes from a compressor extraction (not shown) into second plenum zone 69. The cooling fluid flows into inlet section 118 and along first duct member 108. The cooling fluid then enters cross-flow duct 111 and is guided across generally linear inner surface 113 of flow redirection member 112 into second duct member 109 before passing into, and providing cooling for, the third plurality of nozzles 41. Passing cooling fluid through first duct member 108 in a first direction and through second duct member 109 in a second, opposing, direction establishes a counter-flow within inner casing portion 64. In accordance with an aspect of the exemplary embodiment illustrated in FIGS. 5 and 6, cross-flow duct 111 may be provided with an enlarged cavity area 140 and an effusion plate 145 having a plurality of openings 147 that establish a desired pressure drop between cooling flow exiting second end section 115 of first duct member 108 and cooling fluid entering first end portion 127 of second duct member 109.

In accordance with an aspect of an exemplary embodiment, inner casing portion 64 defines a casing volume V_{C}. In further accordance with an exemplary embodiment, each first duct member 108, second duct member 109, and cross-flow duct 111 collectively define a channel volume V_{Ch}. In accordance with an aspect of an exemplary embodiment, casing volume V_{C} and channel volume V_{Ch} define a volume ratio of about 0.0002<V_{Ch}/V_{C}<0.9. In accordance with another aspect of an exemplary embodiment, casing volume V_{C} and channel volume V_{Ch} define a volume ratio of about 0.01<V_{Ch}/V_{C}<0.74. The volume ratio ensures a desired cooling for inner casing portion 64 and a desired clearance gap over tip portions of the rotating components which can maintain a desired operational efficiency of turbomachine 2. The thermal mass of inner casing portion 64 can be adjusted by changing channel volume V_{Ch} wherein a relatively lower casing thermal mass is provided by a relatively higher channel volume V_{Ch}. A relatively lower casing thermal mass can allow the casing to radially expand or contract more quickly during transient operation. This can allow the casing expansion or contraction to be better-matched to the rotating component expansion or contraction thereby maintaining a desired clearance gap. The aforementioned ratios of V_{Ch}/V_{C} can provide the desired characteristics for casing thermal expansion or contraction.

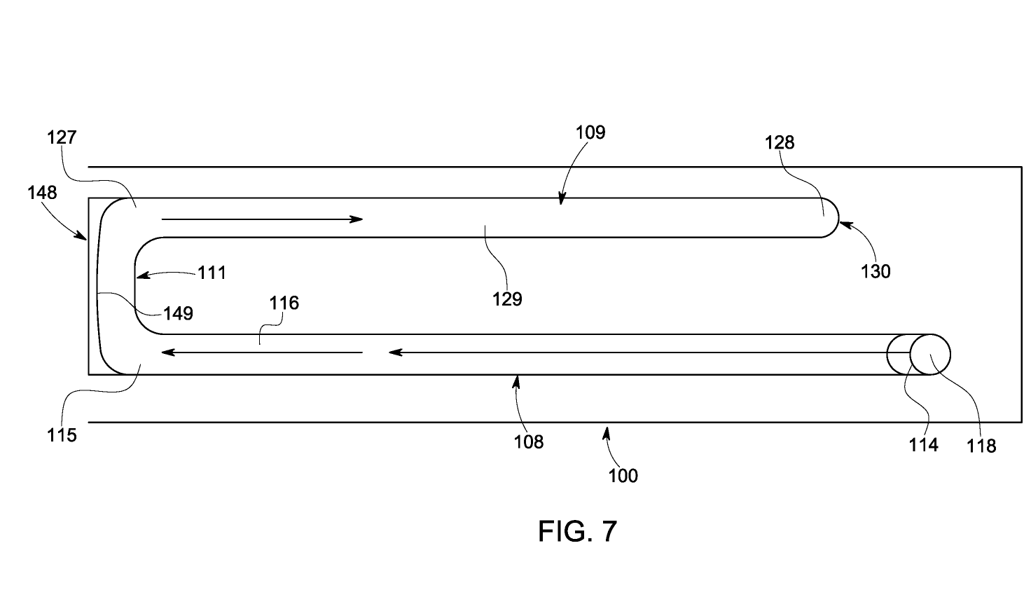

The counter flow reduces circumferential thermal gradients within inner casing portion 64 by providing a heat transfer between the cooling flow passing through first duct member 108 and the cooling flow passing through second duct member 109. Also, embedding counter-flow cooling system 100 within inner casing portion 64 provides deep convection cooling that reduces thermal gradients that may occur in shroud support elements 80-83, and reduces bulk temperatures of the plurality of turbine stages 25 providing a desirable clearance benefit. At this point it should be understood that cross-flow duct 111 may be provided with a flow redirection cap or member 148 having a generally curvilinear surface 149, such as shown in FIG. 7 wherein like reference numbers represent corresponding parts in the respective views. Generally curvilinear surface 149 may be adjusted to establish a desired flow characteristic within counter-flow cooling system 100.

In accordance with one aspect of the exemplary embodiment, turbomachine 2 includes a cooling fluid supply conduit 150 fluidly connected to second plenum zone 69. Cooling fluid supply conduit 150 includes an inlet 151 that is fluidly connected to a compressor extraction (not show). Cooling fluid supply conduit 150 is also shown to include a cooling fluid supply valve 157 and a cooling fluid supply valve bypass 160. Cooling fluid supply valve bypass 160 includes a metered flow orifice (not separately labeled) that allows cooling fluid to pass into second plenum zone 69 when cooling fluid supply valve 157 is closed. In this manner, cooling fluid supply valve bypass 160 maintains desired backflow pressure margins within third plurality of nozzles 41. In further accordance with the exemplary aspect, cooling fluid supply valve 157 is operatively connected to a controller 164. Controller 164 is also coupled to various temperature sensors (not shown). Controller 164 selectively opens cooling fluid supply valve 157 to pass a desired flow of cooling fluid into second plenum zone 69.

The amount of cooling fluid passing into second plenum zone 69 and, more specifically, into counter-flow cooling system 100 may be employed to control a clearance between tip portions (not separately labeled) of buckets 34, 38, 42 and 46 and respective ones of shroud members 86-89. More specifically, during turbomachine 2 start up, clearances between tip portions (not separately labeled) of buckets 34, 38, 42 and 46 and respective ones of shroud members 86-89 are larger than when turbomachine 2 is running at full speed and at full speed-full load. Between start-up and full speed, and between full speed and full speed-full load, rotating components of turbomachine 2 expand at a rate that is faster than an expansion rate of stationary components such as inner casing portion 64, and shroud members 86-89. Different rates of thermal expansion lead to undesirable clearances between the rotating and stationary components. Controlling cooling fluid flow into counter-flow cooling system 100 more closely aligns expansion rates of the rotating components and the stationary components while turbomachine 2 transitions between start-up and full speed and between full speed and full speed-full load operating conditions. Aligning the expansion rates of the rotating components and the stationary components provides tighter clearance gaps during transient and steady state operation of turbomachine 2. The tighter clearance gaps lead to a reduction in working fluid losses over tip portions of the rotating components, improving turbomachine 2 performance and efficiency.

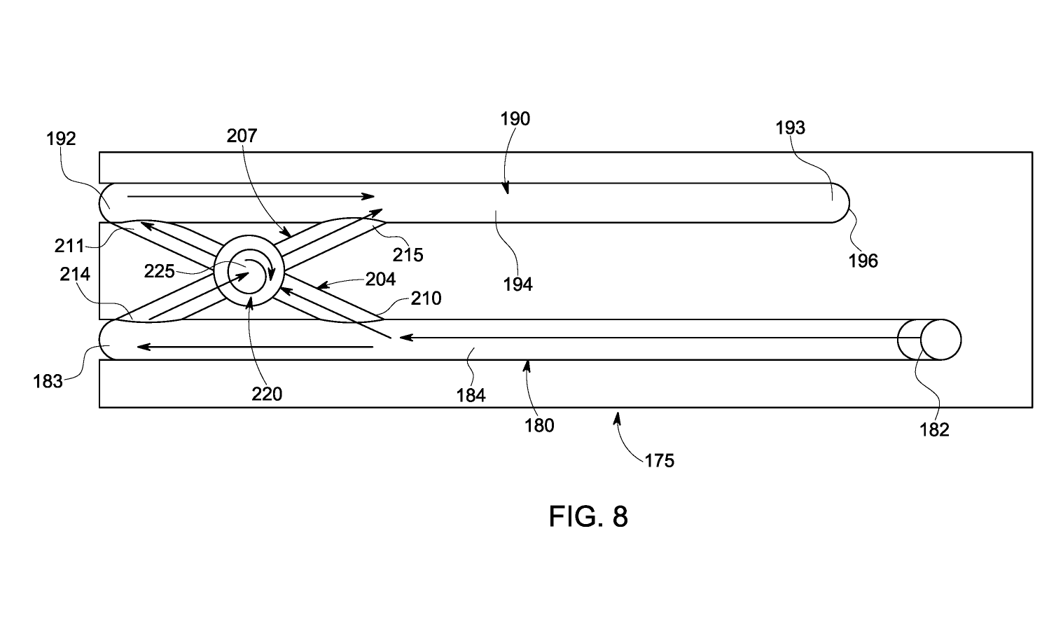

A counter-flow cooling system, in accordance with another aspect of the exemplary embodiment, is indicated generally at 175, in FIG. 8. Counter-flow cooling system 175 includes a first duct member 180 having a first end section 182 that extends to a second end section 183 through an intermediate section 184. Counter-flow cooling system 175 also includes a second duct member 190 that extends generally parallel to first duct member 180 within inner casing portion 64. Second duct member 190 includes a first end portion 192 that extends to a second end portion 193 through an intermediate portion 194. Second end portion 193 is fluidly connected to an exit duct 196 that fluidly connects with the third plurality of nozzles 41.

First duct member 180 is joined to second duct member 190 by a first cross-flow duct 204 and a second cross-flow duct 207. First cross-flow duct 204 includes a first inlet 210 fluidly coupled to intermediate section 184 of first duct member 180 and a first outlet 211 fluidly connected to first end portion 192 of second duct member 190. Second cross-flow duct 207 includes a second inlet 214 that is fluidly connected to second end section 183 of first duct member 180 and a second outlet 215 that is fluidly connected to intermediate portion 194 of second duct member 190. First cross-flow duct 204 is joined to second cross-flow duct 207 by a cross-over duct 220. Cross-over duct 220 establishes a mixing zone 225 for cooling fluid passing through first cross-flow duct 204 and second cross-flow duct 207. Mixing zone 225 aids in equalizing temperatures of the cooling fluid passing through first cross-flow duct 204 and second cross-flow duct 207 to reduce thermal gradients within inner casing portion 64, reducing thermal gradients and bulk temperatures in counter-flow cooling system 175.

At this point it should be understood that the exemplary embodiments provide a counter-flow cooling system for reducing bulk metal temperature and thermal gradients within a turbine portion of a turbomachine. The system also provides deep convection cooling to stationary components, such as inner casings, shroud members, and the like, positioned along a gas path of the turbine. In this manner, the counter-flow cooling system may more closely match or align thermal expansion of stationary turbine components and rotating turbine components. Moreover, cooling flow through the counter-flow cooling system may be selectively controlled to align thermal expansion rates of the stationary components and the rotating components through various operating phases of the turbine. The alignment of the thermal expansion rates reduces clearance gaps between the stationary components and the rotating components particularly when transitioning from one operating phase to another operating phase. The reduction in clearance gaps leads to a reduction in losses in working fluid along the hot gas path, improving performance and efficiency.

It is understood that according to various embodiments, counter-flow cooling system(s) described herein may take the form of a passive clearance control system. By “passive” it should be understood that clearances can be autonomously adjusted based solely on turbomachine operating parameters without any intervention of external programmed control systems and/or personnel.

It should also be understood that while described as being associated with turbine portion 6, a counter-flow cooling system 300 may also be integrated into compressor portion 4 to improve clearances for compressor stages 310. It should be further understood that the counter-flow cooling system 300, in accordance with the exemplary embodiments, may be coupled to external heat exchangers 320 and 330 fluidically connected to compressor portion 4 and turbine portion 6. External heat exchangers 320 and 330 may also be fluidically coupled one to another in accordance with an aspect of the exemplary embodiment to guide cooling flow from the compressor portion 4 to the counter-flow cooling system 300 in the turbine portion 6. In accordance with one aspect of the exemplary embodiment, counter-flow cooling system 300 might extract gases from an upstream section (aft of for example, a sixth stage) (not separately labeled) of compressor portion 4, pass the gases through external heat exchanger 320 and then a casing portion (not separately labeled) of compressor portion 4 and onto turbine section 6. The gases flowing through compressor portion 4 will enhance uniformity of thermal expansion thereby allowing designers to employ tighter tip clearance tolerance to enhance compressor efficiency. The presence of one or more external heat exchangers provides additional conditioning to the cooling flow to further enhance clearance control with turbomachine 2.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A gas turbomachine comprising:
a casing assembly surrounding a portion of the gas turbomachine the casing assembly including an inner casing portion defining a casing volume V_{C}; and
a counter-flow cooling system arranged within the inner casing portion, the counter-flow cooling system including a plurality of ducts collectively defining a channel volume V_{Ch}, the plurality of ducts being configured and disposed to guide cooling fluid through the casing assembly in a first axial direction and return cooling fluid through the casing assembly in a second axial direction that is opposite the first axial direction, wherein the casing volume and the channel volume define a volume ratio of about 0.0002<V_{Ch}/V_{C}<0.9.

2. The gas turbomachine according to claim 1, wherein the plurality of duct members includes a first duct member extending axially through the casing assembly, a second duct member spaced from, and extending substantially parallel to, the first duct member, and at least one cross-flow duct linking the first and second duct members.

3. The gas turbomachine according to claim 2, wherein the at least one cross-flow duct includes a flow redirection member.

4. The gas turbomachine according to claim 3, wherein the flow redirection member includes a curvilinear surface.

5. The gas turbomachine according to claim 2, wherein the at least one cross-flow duct includes a first a cross-flow duct and a second cross flow duct, each of the first and second cross-flow ducts linking the first and second duct members.

6. The gas turbomachine according to claim 5, further comprising: a cross-over duct fluidly connecting the first and second cross-flow ducts.

7. The gas turbomachine according to claim 1, wherein the casing assembly includes an outer casing portion and an inner casing portion, the counter-flow cooling system being arranged within the inner casing portion.

8. The gas turbomachine according to claim 7, wherein the inner casing portion includes a plurality of shroud support elements, the counter-flow cooling system extending through at least two of the plurality of shroud support elements.

9. The gas turbomachine according to claim 1, further comprising: a cooling fluid supply conduit fluidly connected to the counter-flow cooling system, the cooling fluid supply conduit including a cooling fluid supply valve that is selectively operated to deliver cooling fluid to the counter-flow cooling system.

10. The gas turbomachine according to claim 9, further comprising: a cooling fluid supply valve bypass connected in parallel to the cooling fluid supply valve, the cooling fluid supply valve bypass being configured and disposed to permit an amount of cooling fluid to pass through the counter-flow cooling system when the cooling fluid supply valve is closed.

11. The gas turbomachine according to claim 9, further comprising: a controller operatively connected to the cooling fluid supply valve, the controller being configured and disposed to selectively open the cooling fluid supply valve to deliver an amount of cooling fluid into the counter-flow cooling system.

12. The gas turbomachine according to claim 1, wherein the counter-flow cooling system is arranged within a turbine portion.

13. The gas turbomachine according to claim 1, further comprising: an external heat exchanger fluidically connected to the counter-flow cooling system.

14. The gas turbomachine according to claim 1, wherein the volume ratio is about 0.01<V_{Ch}/V_{C}<0.74.

15. A method of delivering cooling fluid through a gas turbomachine, the method comprising:
guiding a cooling fluid into a casing assembly of the gas turbomachine, the casing assembly including an inner casing portion defining a casing volume V_{C};
passing the cooling fluid into a first duct member extending axially through the casing assembly in a first direction;
guiding the cooling fluid through a cross-flow duct fluidly coupled to the first duct member in a second direction;
delivering the cooling fluid from the cross-flow duct into a second duct member that extends substantially parallel to the first duct member, wherein the first duct member, cross-flow duct, and second duct member define a channel volume V_{Ch}; and
passing the cooling fluid through the second duct member in a third direction that is substantially opposite to the first direction, wherein the casing volume and the channel volume define a volume ratio of about 0.0002<V_{Ch}/V_{C}<0.9.

16. The method of claim 15, wherein guiding the cooling fluid into the casing assembly includes guiding the cooling fluid into an inner casing portion of the casing assembly.

17. The method of claim 15, wherein passing the cooling fluid through the first duct member includes passing the cooling fluid through at least two shroud support elements.

18. The method of claim 15, further comprising: wherein guiding the cooling fluid into the casing assembly includes opening a cooling fluid supply valve.

19. The method of claim 18, further comprising: bypassing the cooling fluid supply valve with an amount of cooling fluid when the cooling fluid supply valve is closed to maintain backflow margin within a nozzle of the turbine portion.

20. The method of claim 15, further comprising: guiding a portion of the cooling fluid from the one of the first and second duct members and cross-flow duct into a nozzle of the turbine portion.

21. The method of claim 15, wherein guiding a cooling fluid into the casing assembly includes delivering the cooling fluid from a compressor portion extraction into a turbine portion of the gas turbomachine.

22. The method of claim 15, wherein guiding a cooling fluid into the casing assembly includes delivering the cooling fluid into a casing assembly housing a compressor portion of the gas turbomachine.

23. The method of claim 15, wherein guiding the cooling fluid into the casing assembly includes passing the cooling fluid from an external heat exchanger into the casing assembly.

24. A gas turbomachine comprising:
a compressor portion;
a combustor assembly fluidly connected to the compressor portion; and
a turbine portion fluidly connected to the combustor assembly and mechanically linked to the compressor portion, one of the compressor portion and the turbine portion including a casing assembly having an inner casing portion defining a casing volume V_{C}; and
a counter-flow cooling system arranged in one of the compressor portion and the turbine portion, the counter-flow cooling system including a plurality of ducts collectively defining a channel volume V_{Ch}., the plurality of ducts being configured and disposed to guide cooling fluid through the casing assembly in a first axial direction and return cooling fluid through the casing assembly in a second axial direction that is opposite the first axial direction, wherein the casing volume and the channel volume define a volume ratio of about 0.0002<V_{Ch}/V_{C}<0.9.

25. The gas turbomachine according to claim 24, wherein the counter-flow cooling system includes a first duct member extending axially through the casing assembly, a second duct member spaced from, and extending substantially parallel to, the first duct member and a cross-flow duct linking the first and second duct members.

26. The gas turbomachine according to claim 25, wherein the cross-flow duct includes a flow redirection member.

27. The gas turbomachine according to claim 25, wherein the flow redirection member includes a curvilinear surface.

28. The gas turbomachine according to claim 24, wherein the casing assembly includes an outer casing portion and an inner casing portion, the counter-flow cooling system being arranged within the inner casing portion.

29. The gas turbomachine according to claim 24, further comprising:
a cooling fluid supply conduit fluidly connected to the counter-flow cooling system, the cooling fluid supply conduit including a cooling fluid supply valve that is selectively operated to deliver cooling fluid to the counter-flow cooling system; and
a controller operatively connected to the cooling fluid supply valve, the controller being configured and disposed to selectively open the cooling fluid supply valve to deliver an amount of cooling fluid into the counter-flow cooling system.

30. The gas turbomachine according to claim 24, wherein the counter-flow cooling system is arranged in the turbine portion.

31. The gas turbomachine according to claim 24, further comprising: an external heat exchanger fluidically connected to the counter-flow cooling system.

32. The gas turbomachine according to claim 24, wherein the volume ratio is about 0.01<V_{Ch}/V_{C}<0.74.
